(19) United States
(12) Patent Application Publication
(10) Pub. No.: US 2007/0229403 A1
(43) Pub. Date: Oct. 4, 2007

(54) Plasma display unit and method of driving the same

(75) Inventor: Naruhiro Sato, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Tokyo (JP)

(21) Appl. No.: 11/727,943

(22) Filed: Mar. 29, 2007

(30) Foreign Application Priority Data
Mar. 29, 2006 (JP) 2006-091130

(51) Int. Cl. G09G 3/28

(52) U.S. Cl. 345/60

(57) ABSTRACT

A plasma display unit includes a plasma display panel having a plurality of display cells, wherein a display cell to be lit is selected among the display cells by applying a scan pulse thereto, and sustaining discharge is generated in the selected display cell for causing the selected display cell to light, and further includes a first device for determining a width of a scan pulse in accordance with a delay time starting when a scan pulse is applied to a display cell and terminating when discharge is generated in the display cell, a second device for determining an offset in a voltage of a scan pulse in accordance with a scan pulse width determined by the first device, the offset being defined as a voltage offset from a standard voltage, and a third device for outputting a scan pulse having the offset voltage defined as a sum of the standard voltage and the offset, to the plasma display panel.

### BACKGROUND OF THE INVENTION

1. Field of the Invention

The invention relates to a plasma display unit, a method of driving the same, and a program for causing a computer to carry out the method.

2. Description of the Related Art

FIG. 1 illustrates a part of a time chart showing waveforms of drive signals for driving a plasma display panel (PDP). A plasma display panel is driven in accordance with a selective-erasion drive process.

As illustrated in FIG. 1, in order to drive a plasma display panel, an address control signal is applied to a desired address electrode among a plurality of address electrodes in a selection period, and further, a scan pulse is applied to a desired scanning electrode among a plurality of scanning electrodes in the selection period. As a result, a display cell to be lit is selected among a plurality of display cells of a plasma display panel.

In a plasma display panel, selective discharge is not generated immediately after a voltage for initiating generation of discharges is applied across a Y-side electrode (a scanning electrode) and an address electrode. That is, selective discharge is generated slightly after the application of a voltage across a Y-side electrode and an address electrode. In other words, there exists a discharge delay time after a voltage was applied across a Y-side electrode and an address electrode until selective discharge is actually generated.

Furthermore, a discharge delay time is not always constant, but varies in accordance with the lapse of time after the previous sustaining discharge period has terminated.

FIG. 2 is a graph showing a relation between the lapse of time after the previous sustaining discharge period has terminated (axis of abscissas), and a scan discharge delay time (axis of coordinates).

As shown in FIG. 2, as a period of time after the previous sustaining discharge period has terminated becomes longer, a scan discharge delay time becomes longer.

A difference in a discharge delay time exerts harmful influence on display quality of a plasma display panel. Thus, an attempt has been made to suppress such a difference in a discharge delay time, for instance, in Japanese Patent Application Publications Nos. 2003-76319 and 2001-242823.

Specifically, the above-mentioned Publications suggest a method of driving a plasma display panel, in which a scan pulse width (a period of time of a single scan pulse) is varied in each of scanning lines in a sub-field of a sequence, taking a discharge delay time into consideration, and thereby, a discharge delay time generated in accordance with the lapse of time after the previous sustaining discharge period has terminated is prevented from varying.

Hereinafter are explained the reason why it is necessary to vary a scan pulse width in each of scanning lines both in the selective erasion process and the selective writing process.

In the selective erasion process, an amount of electrically charge particles generated due to sustaining discharges in the previous sub-field tends to reduce with the lapse of time. Accordingly, comparing scanning a first display line to scanning a final display line, since lines are scanned in turn, there exists a time difference in the lapse of time after sustaining discharge in the previous sub-field has been terminated, and an amount of electrically charges particle reduces as the lapse of time becomes long. It is necessary to intensify a writing discharge in order to stably generate a writing discharge (a selective discharge) under such conditions, and hence, it is necessary to widen a scan pulse width

In the selective writing process, if a plasma display panel is driven in accordance with the scanning-sustaining separation drive process, a surface discharge is generated entirely over a surface for entirely clearing display data in an initialization period, and thereby, wall charges existing on surface electrodes are all erased. Otherwise, since an amount of wall charges are different between a cell having been lit in the previous sub-field and a cell not having been lit in the previous sub-field, it would not be possible to uniformly select cells, even if a scan pulse is applied to a scanning electrode in the next step, that is, in the next scanning period. Thus, wall charges in all cells are uniformized in an initialization period.

In a scanning period, a scan pulse is applied only to a cell or cells to be lit, based on display information brought by image signals, to thereby generate wall charges necessary for lighting a selected cell. At this stage, there is a difference in an amount of wall charges between a cell not to be lit and a cell to be lit.

In a sustaining period, a sustaining pulse is applied to a cell to be lit with the result that a voltage of the sustaining pulse is combined to the wall charges generated in the previous scanning period in a cell to be lit, and thus, a voltage greater than a voltage at which a discharge is generated is generated. Thus, there is generated a sustaining discharge.

In contrast, even if a sustaining pulse is applied to a cell not to be lit, there are generated merely wall charges which do not make a voltage greater than a voltage at which a discharge is generated, if combined to a voltage of the sustaining pulse. Accordingly, there is not generated a sustaining discharge.

In the scanning period, a large amount of electrically charged particles exists in a cell immediately after an initialization discharge is generated in the first initialization period. However, the electrically charged particles reduce in a number with the lapse of time.

Accordingly, a scan pulse (corresponding to a first scanning line if lines are scanned in turn) applied to a cell immediately after the initialization period surely generates a writing discharge, since a large amount of electrically charged particles still exists.

However, since long time lapses after the initialization period, an amount of electrically charged particles in a cell much reduces in lines close to a final line, comparing an amount of electrically charged particles existing immediately after the initialization period.

Hence, even if the same scan pulse is applied to a cell, a probability at which a writing discharge is generated much lowers in comparison with the probability obtained immediately after starting application of a scan pulse.

This means that it will be more difficult to generate a writing discharge in lines closer to a final line, resulting in wrong selection of a cell to be lit.

In order to reduce such wrong selection, it is necessary in the selective writing process to vary a scan pulse width line by line, or lines by lines.

A scan pulse width is made wider in lines closer to a final line in order to ensure increasing a discharge intensity to surely generate a writing discharge.

However, the conventional process in which a scan pulse width is varied in accordance with a length of a discharge delay time is accompanied with the following problem.

First, an offset voltage is explained hereinbelow.

An offset voltage is defined as a voltage to be applied to a Y electrode (a scanning electrode) as a writing pulse voltage. If the writing pulse voltage is positive relative to a reference voltage (for instance, a ground voltage) of a Y electrode, the offset voltage is shifted toward a negative voltage, and if the writing pulse voltage is negative relative to a reference voltage of a Y electrode, the offset voltage is shifted toward a positive voltage. In FIG. 1, an offset voltage is expressed as “Ofs”.

An offset voltage has a minimum offset voltage and a maximum offset voltage. If an offset voltage is between a minimum offset voltage and a maximum offset voltage, it is possible to stably generate a selective discharge.

A minimum offset voltage is defined as such a voltage that if an offset voltage is below the minimum offset voltage, it would not be possible to sufficiently write (select) cells entirely in a screen. That is, if an offset voltage is below the minimum offset voltage, since it is not possible to generate wall charges (which are generated on surface electrodes after generation of writing discharges) necessary for the next sustaining period, there would be caused problems that a cell to be lit does not light, or a cell not to be lit lights.

A maximum offset voltage is defined as such a voltage that if an offset voltage is above the maximum offset voltage, a discharge intensity becomes too high, resulting in that wall charges is generated too excessively, and there is caused unbalance among an amount of wall charges generated above surface electrodes. Accordingly, if an offset voltage is above the maximum offset voltage, there would be caused problems that a cell to be lit does not light, or a cell not to be lit lights, similarly to a case where an offset voltage is below the minimum offset voltage.

For the reasons mentioned above, it is necessary to keep an offset voltage between a maximum offset voltage and a minimum offset voltage.

FIG. 3 is a graph showing a relation between a scan pulse width (axis of abscissas) and maximum and minimum offset voltages (axis of coordinates).

Specifically, FIG. 3 illustrates a curve A showing a minimum offset voltage, and a curve B showing a maximum offset voltage.

Hereinbelow, a range of voltages sandwiched between the maximum and minimum offset voltages is referred to as an offset margin.

As illustrated in FIG. 3, the maximum offset voltage shown as the curve B becomes smaller as a scan pulse width becomes greater, and similarly, the minimum offset voltage shown as the curve A becomes smaller as a scan pulse width becomes greater.

The conventional method of driving a plasma display panel is accompanied with a problem that since an offset voltage is kept at a constant voltage, an offset voltage is not always within the offset margin in all of scan pulse widths.

Specifically, supposing that an offset voltage is set to be 50V, if a scan pulse width becomes greater than a width C, an offset voltage would be above the maximum offset voltage, that is, an offset voltage would be out of the offset margin.

As an alternative, supposing that an offset voltage is set to be 44V, if a scan pulse width becomes smaller than a width D, an offset voltage would be below the minimum offset voltage, that is, an offset voltage would be out of the offset margin.

The offset margin varies in accordance with various factors such as a cell structure in a plasma display panel, a kind of discharge gas, a process of fabricating a plasma display panel, and so on. Hence, it was necessary to determine an offset voltage in each of plasma display panels when they are fabricated, and if it was not possible to set an offset voltage within the offset margin, a plasma display panel to which such an offset voltage is set has to be abandoned.

The voltages indicated with the curves A and B in FIG. 3 are just examples, and are determined in accordance with characteristics of each of plasma display panels.

As mentioned above, the conventional plasma display panel in which a scan pulse width is varied in accordance with a length of a scan discharge delay time is accompanied with a problem that it is not possible to broadly vary a range of a scan pulse width in a plasma display panel having a narrow offset margin.

### SUMMARY OF THE INVENTION

In view of the above-mentioned problem in the conventional plasma display panel, it is an object of the present invention to provide a plasma display unit which is capable of broadly varying a range of a scan pulse width.

It is also an object of the present invention to provide a method of driving a plasma display unit which is capable of doing the same.

It is further an object of the present invention to provide a program for causing a computer to carry out the above-mentioned method.

In one aspect of the present invention, there is provided a plasma display unit including a plasma display panel having a plurality of display cells, wherein a display cell to be lit is selected among the display cells by applying a scan pulse thereto, and sustaining discharge is generated in the selected display cell for causing the selected display cell to light, the plasma display unit including a first device for determining a width of a scan pulse in accordance with a delay time starting when a scan pulse is applied to a display cell and terminating when discharge is generated in the display cell, a second device for determining an offset in a voltage of a scan pulse in accordance with a scan pulse width determined by the first device, the offset being defined as a voltage offset from a standard voltage, and a third device for outputting a scan pulse having the offset voltage defined as a sum of the standard voltage and the offset, to the plasma display panel.

For instance, the second device may be designed to include a table storing therein both a plurality of scan pulse widths, and optimal offset voltages each associated with each of the scan pulse widths, and a fourth device for retrieving the table to determine an optimal offset voltage associated with a scan pulse.

The plasma display unit may further include a plurality of voltage sources each associated with each of a plurality of offset voltages, a plurality of switches each associated with each of the voltage sources, and a controller for controlling the switches in accordance with the offset determined by the second device to select one of the switches for allowing the associated offset voltage to output through the selected switch.

It is preferable that the second device varies the offset in a step-shaped voltage such that an offset voltage becomes smaller as a scan pulse width becomes greater.

It is preferable that the second device linearly varies the offset such that an offset voltage becomes smaller as a scan pulse width becomes greater.

It is preferable that the second device varies the offset in a curve such that an offset voltage becomes smaller as a scan pulse width becomes greater.

In another aspect of the present invention, there is provided a method of driving a plasma display unit including a plasma display panel having a plurality of display cells, wherein a display cell to be lit is selected among the display cells by applying a scan pulse thereto, and sustaining discharge is generated in the selected display cell for causing the selected display cell to light, the method including (a) determining a width of a scan pulse in accordance with a delay time starting when a scan pulse is applied to a display cell and terminating when discharge is generated in the display cell, and (b) determining an offset in a voltage of a scan pulse in accordance with a scan pulse width determined by the first device, the offset being defined as a voltage offset from a standard voltage.

In the above-mentioned method, it is preferable that the (b) includes retrieving a table to determine the offset, the table storing therein both a plurality of scan pulse widths, and optimal offsets each associated with each of the scan pulse widths.

In still another aspect of the present invention, there is provided a program for causing a computer to carry out a method of driving a plasma display unit including a plasma display panel having a plurality of display cells, wherein a display cell to be lit is selected among the display cells by applying a scan pulse thereto, and sustaining discharge is generated in the selected display cell for causing the selected display cell to light, steps executed by the computer in accordance with the program, including (a) determining a width of a scan pulse in accordance with a delay time starting when a scan pulse is applied to a display cell and terminating when discharge is generated in the display cell, and (b) determining an offset in a voltage of a scan pulse in accordance with a scan pulse width determined by the first device, the offset being defined as a voltage offset from a standard voltage.

In the above-mentioned program, it is preferable that the (b) includes retrieving a table to determine the offset, the table storing therein both a plurality of scan pulse widths, and optimal offsets each associated with each of the scan pulse widths.

The advantages obtained by the aforementioned present invention will be described hereinbelow.

The present invention makes it possible to set an offset voltage of a scan pulse within an offset margin, even if an offset margin is narrow. Accordingly, it is possible to broadly vary a range of a scan pulse width, even if an offset margin is narrow.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 illustrates a part of a time chart showing waveforms of drive signals for driving a plasma display panel (PDP).

FIG. 2 is a graph showing a relation between the lapse of time after the previous sustaining discharge period has terminated (axis of abscissas), and a scan discharge delay time (axis of coordinates).

FIG. 3 is a graph showing a relation between a scan pulse width (axis of abscissas) and maximum and minimum offset voltages (axis of coordinates).

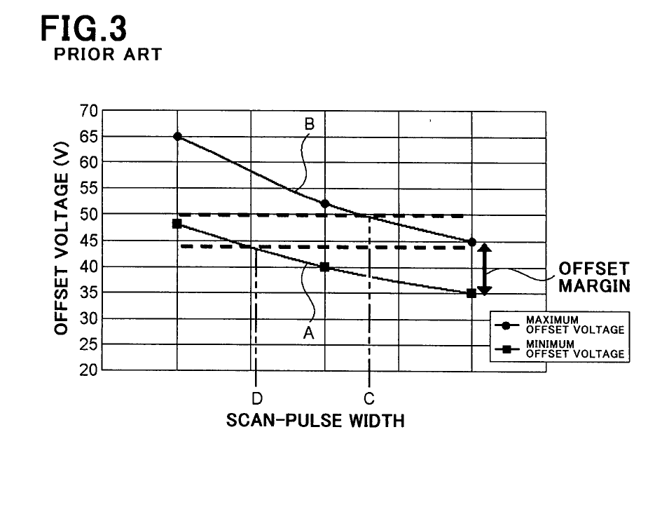

FIG. 4 is a block diagram illustrating a structure of a plasma display unit in accordance with the first embodiment of the present invention.

FIG. 5 is a graph showing a relation between a scan pulse width (axis of abscissas) and maximum and minimum offset voltages (axis of coordinates).

FIG. 6 is a circuit diagram of the offset voltage generator.

FIG. 7 is a block diagram of an example of a microcomputer.

FIG. 8 is an exploded perspective view of the plasma display panel constituting the plasma display unit in accordance with the first embodiment.

FIG. 9 is a block diagram of a plasma display apparatus including the plasma display unit in accordance with the first embodiment.

### DESCRIPTION OF THE PREFERRED EMBODIMENTS

Preferred embodiments in accordance with the present invention will be explained hereinbelow with reference to drawings.

### First Embodiment

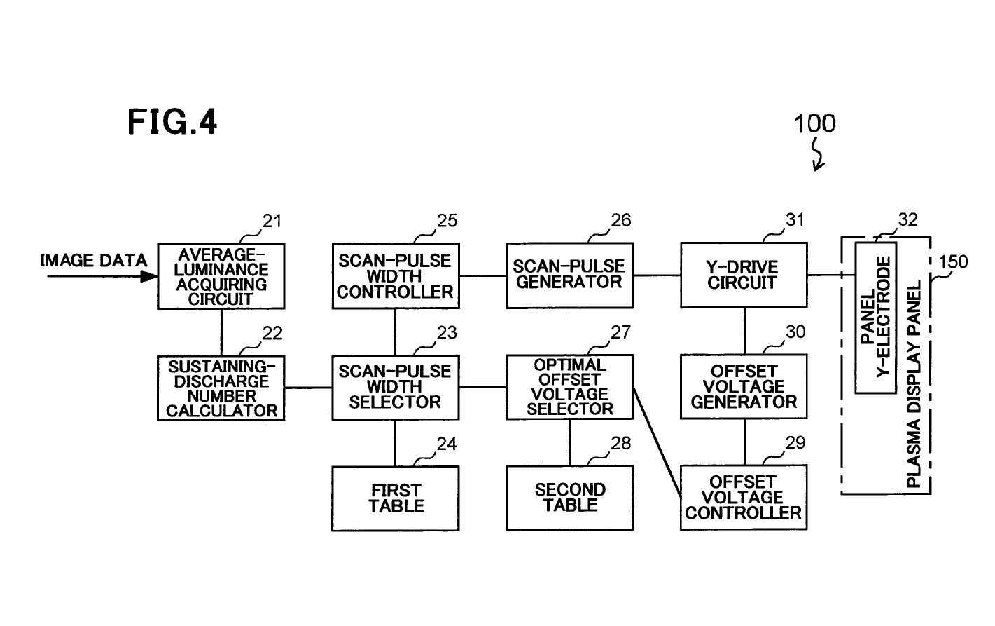

FIG. 4 is a block diagram illustrating a structure of a plasma display unit 100 in accordance with the first embodiment of the present invention.

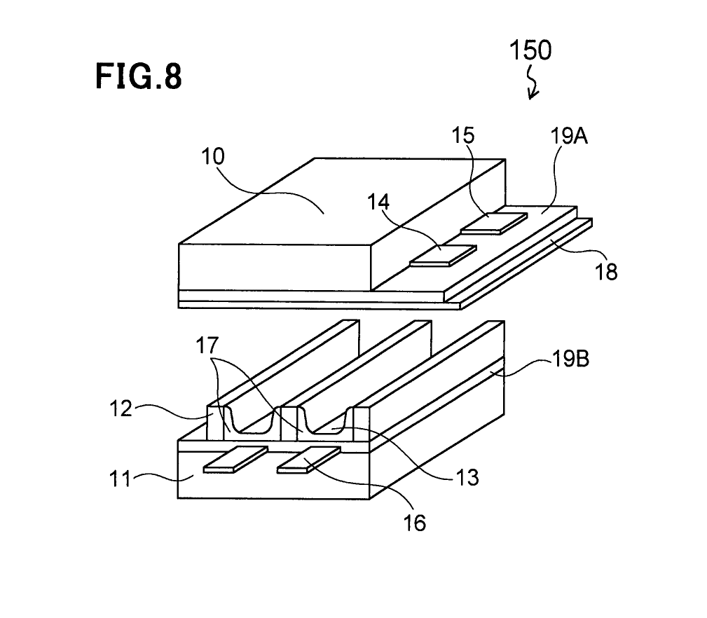

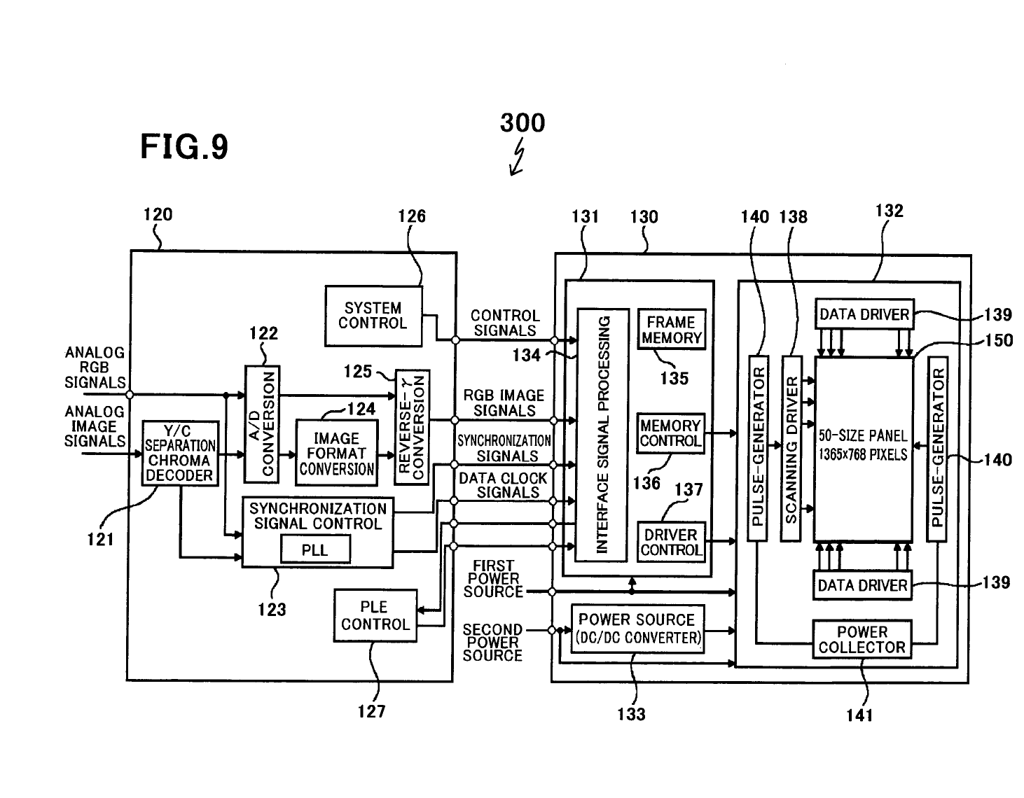

As illustrated in FIG. 4, the plasma display unit 100 is comprised of an average-luminance acquiring circuit 21 for taking data indicative of an average luminance of images out of image data input into the plasma display unit 100, a sustaining-discharge number calculator 22 for calculating a number of sustaining discharges to be generated in each of sub-fields in accordance with the average luminance data provided by the average-luminance acquiring circuit 21, a scan-pulse width selector 23 for calculating a discharge delay time starting when a scan pulse is applied to the plasma display unit 100 and terminating at a selective discharge is generated, in accordance with a number of sustaining discharges calculated by the sustaining-discharge number calculator 22, and selects an optimal scan pulse width in accordance with the thus calculated discharge delay time, a first table 24 storing therein a plurality of numbers of sustaining discharges in each of sub-fields, and a plurality of optimal scan pulse widths each associated with each of the numbers of sustaining discharges in each of sub-fields, the first table 24 being used by the scan-pulse width selector 23 for selecting an optimal scan pulse width, a scan-pulse width controller 25 for controlling a width of a scan pulse in accordance with the selection carried out by the scan-pulse width selector 23, a scan pulse generator 26 outputting a scan pulse having a width controlled by the scan-pulse width controller 25, an optimal offset voltage selector 27 for selecting an optimal offset voltage in accordance with the selection carried out by the scan-pulse width selector 23, a second table 28 storing therein a plurality of scan-pulse widths, and a plurality of optimal offset voltages each associated with each of the scan-pulse widths, the second table 28 being used by the optimal offset voltage selector 27 for selecting an optimal offset voltage, an offset voltage controller 29 for controlling an offset voltage in accordance with the selection carried out by the optimal offset voltage selector 27, an offset voltage generator 30 for generating an offset voltage controlled by the offset voltage controller 29, a Y-drive circuit 31 which sets an offset voltage of a scan pulse generated by the scan pulse generator to be equal to an offset voltage generated by the offset voltage generator 30, and outputs a scan pulse having the offset voltage to a panel Y-electrode 32 of a plasma display panel 150 (see FIGS. 8 and 9), and a plasma display panel 150 including a panel Y-electrode 32.

As illustrated in FIG. 9, when the plasma display panel 150 is to be driven, a drive signal is applied at a predetermined timing to one of a Y-electrode (scanning electrode), a sustaining electrode and a data electrode (address electrode) to thereby generate discharge in a selected cell or cells among a plurality of cells of the plasma display panel 150. As a result, the selected cell or cells is lit, and thus, desired images are displayed in a screen of the plasma display panel 150.

A waveform of a signal to be applied to a Y electrode (scanning electrode), a sustaining electrode and a data electrode (address electrode) has a sub-field (SF) as a fundamental unit. A series of images are displayed by repeatedly carrying out actions to be done in a sub-field.

A sub-field is comprised of, in sequence of, a sustaining eliminating period, a preliminary discharge period, a selection period (a scanning period), and a sustaining period.

In the selection period, an address control signal is applied to a desired address electrode among a plurality of address electrodes of the plasma display panel 150, and further, a scan pulse P is applied to a desired scanning electrode among a plurality of scanning electrodes of the plasma display panel 150. As a result, a display cell or display cells to be lit is(are) selected among a plurality of display cells of the plasma display panel 150.

In the sustaining period, sustaining discharges are generated in the selected display cell(s) in a number dependent on luminance data included in image data.

In a plasma display panel, selective discharge is not generated in the selection period immediately after a voltage for initiating generation of discharges is applied across a Y-side electrode (a scanning electrode) and an address electrode. That is, selective discharge is generated slightly after the application of a voltage across a Y-side electrode and an address electrode. In other words, there exists a discharge delay time after a voltage was applied across a Y-side electrode and an address electrode until selective discharge is actually generated.

Furthermore, a discharge delay time is not always constant, but varies in accordance with both the lapse of time after the previous sustaining discharge period has terminated and a number of sustaining discharges generated in the previous sub-field.

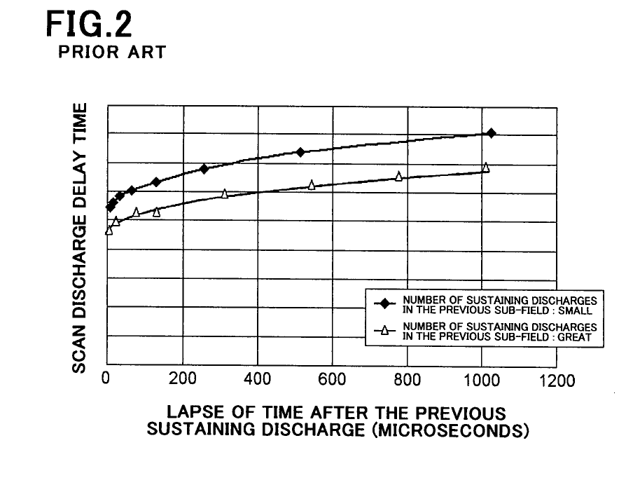

FIG. 2 is a graph showing a relation between the lapse of time after the previous sustaining discharge period has terminated (axis of abscissas), and a scan discharge delay time (axis of coordinates).

As shown in FIG. 2, as a period of time after the previous sustaining discharge period has terminated becomes longer, a scan discharge delay time becomes longer, and as a number of sustaining discharges generated in the previous sub-field is greater, a scan discharge delay time becomes shorter.

A difference in a discharge delay time exerts harmful influence on display quality of a plasma display panel.

The plasma display unit 100 in accordance with the first embodiment varies a width of a scan pulse in accordance with a length of a discharge delay time to thereby minimize variance of a discharge delay time caused in accordance with the lapse of time after the termination of the previous sustaining discharge period.

Hereinbelow is explained an operation of the plasma display unit 100 in accordance with the first embodiment.

The first table 24 stores therein a plurality of numbers of sustaining discharges in each of sub-fields, and a plurality of optimal widths of a scan pulse each associated with each of the numbers of sustaining discharges in each of sub-fields.

The scan-pulse width selector 23 retrieves the first table 24 to thereby select an optimal scan pulse width in accordance with a number of sustaining discharges in each of sub-fields, calculated by the sustaining-discharge number calculator 22. That is, scan-pulse width selector 23 reads a scan pulse width associated with a number of sustaining discharges in each of sub-fields, calculated by the sustaining-discharge number calculator 22, out of the first table 24.

Then, the scan-pulse width selector 23 outputs the selected scan pulse width (a width of a scan pulse read out of the first table 24) to both the scan-pulse width controller 25 and the optimal offset voltage selector 27.

Thus, a width of a scan pulse (a length of a period of time during which a scan pulse is active) is varied in accordance with a length of a discharge delay time. As a result, it is possible to suppress variance of a discharge delay time caused in accordance with the lapse of time after the previous sustaining discharge period has terminated.

The scan-pulse width selector 23 and the first table 24 defines a first device for determining a width of a scan pulse in accordance with a delay time starting when a scan pulse is applied to a display cell and terminating when discharge is generated in the display cell.

The scan-pulse width controller 25 controls the scan pulse generator 26 in accordance with the scan pulse width selected by the scan-pulse width selector 23, to thereby control a width of a scan pulse.

For instance, the scan-pulse width controller 25 carries out CLK number modulation to the scan pulse generator 26 to thereby control a width of a scan pulse. Specifically, the scan-pulse width controller 25 includes a memory for carrying out CLK number modulation, and controls a width of a scan pulse by mandatorily varying a scan pulse to be output from the scan pulse generator 26, in accordance with what is stored in the memory.

What is stored in the memory of the scan-pulse width controller 25 is rewritten in accordance with the selection carried out by the scan-pulse width selector 23.

The scan pulse generator 26 generates a scan pulse having a width controlled by the scan-pulse width controller 25, and outputs the thus generated scan pulse to the Y-drive circuit 31.

For instance, the scan pulse generator 26 is comprised of a pattern generator which includes a memory storing therein predetermined scan-pulse generation patterns, and outputs a low level and a high level both in a predetermined period to the Y-drive circuit 31.

A scan pulse generated by the scan pulse generator 26 has a voltage not yet determined. That is, an offset voltage is not yet determined. A scan pulse generated by the scan pulse generator 26 defines only a width and a timing of a scan pulse. The Y-drive circuit 31 produces a scan pulse as a final pulse.

The second table 28 stores therein a plurality of scan-pulse widths, and a plurality of optimal offset voltages each associated with each of the scan-pulse widths.

The optimal offset voltage selector 27 retrieves the second table 28 to thereby select an optimal offset voltage in accordance with the selection carried out by the optimal offset voltage selector 27.

Specifically, the optimal offset voltage selector 27 reads an offset voltage associated with a scan pulse width input from the scan-pulse width selector 23, out of the second table 28.

Furthermore, the optimal offset voltage selector 27 outputs the read-out offset voltage to the offset voltage controller 29.

The optimal offset voltage selector 27 and the second table 28 defines a second device for determining an offset in a voltage of a scan pulse in accordance with a scan pulse width determined by the above-mentioned first device. Herein, the offset is defined as a voltage offset from a standard voltage.

The offset voltage controller 29 controls the offset voltage generator 30 in accordance with the offset voltage received from the optimal offset voltage selector 27 to thereby cause the offset voltage generator 30 to output an optimal offset voltage associated with a scan pulse width, to the Y-drive circuit 31.

The Y-drive circuit 31 offsets a low-level voltage of a scan pulse received from the scan pulse generator 26 such that the low-level voltage is equal to an offset voltage output from the offset voltage generator 30, and then, outputs a scan pulse having the offset voltage to the plasma display panel 150.

That is, a scan pulse output to the plasma display panel 150 from the Y-drive circuit 31 has both a width controlled by the scan-pulse width controller 25, and an offset voltage controlled by the offset voltage controller 29.

The Y-drive circuit 31 defines a third device for outputting a scan pulse having an offset voltage defined as a sum of a standard voltage and an offset defined by the above-mentioned second device, to the plasma display panel 150.

Hereinbelow is explained an offset voltage output from the offset voltage generator 30.

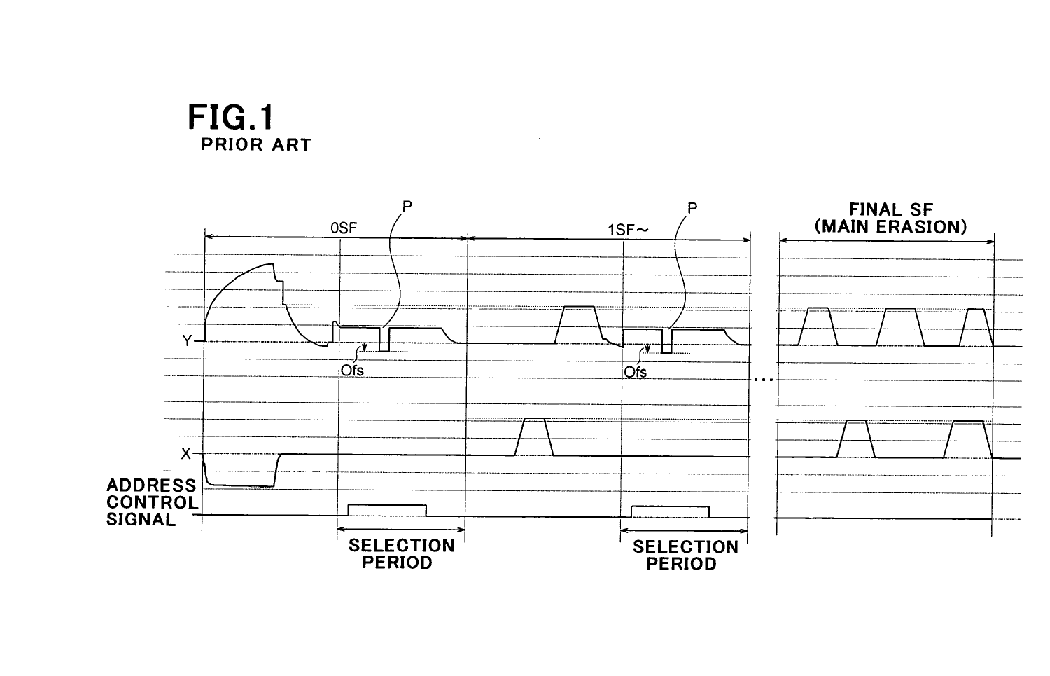

An offset voltage is defined as a voltage to be applied to a Y electrode (a scanning electrode) as a writing pulse voltage. If the writing pulse voltage is positive relative to a reference voltage (for instance, a ground voltage) of a Y electrode, the offset voltage is shifted toward a negative voltage, and if the writing pulse voltage is negative relative to a reference voltage of a Y electrode, the offset voltage is shifted toward a positive voltage. In FIG. 1, an offset voltage is expressed as “Ofs”.

An offset voltage has a minimum offset voltage and a maximum offset voltage. If an offset voltage is between a minimum offset voltage and a maximum offset voltage, it is possible to stably generate a selective discharge.

A minimum offset voltage is defined as such a voltage that if an offset voltage is below the minimum offset voltage, it would not be possible to sufficiently write (select) cells entirely in a screen. That is, if an offset voltage is below the minimum offset voltage, since it is not possible to generate wall charges (which are generated on surface electrodes after generation of writing discharges) necessary for the next sustaining period, there would be caused problems that a cell to be lit does not light, or a cell not to be lit lights.

A maximum offset voltage is defined as such a voltage that if an offset voltage is above the maximum offset voltage, a discharge intensity becomes too high, resulting in that wall charges is generated too excessively, and there is caused unbalance among an amount of wall charges generated above surface electrodes. Accordingly, if an offset voltage is above the maximum offset voltage, there would be caused problems that a cell to be lit does not light, or a cell not to be lit lights, similarly to a case where an offset voltage is below the minimum offset voltage.

For the reasons mentioned above, it is necessary to keep an offset voltage between a maximum offset voltage and a minimum offset voltage.

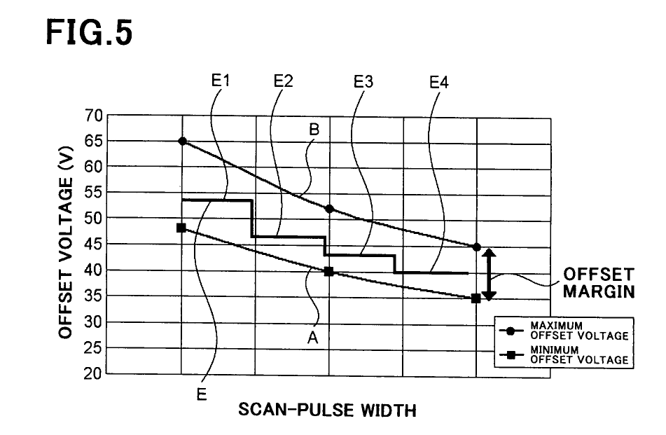

FIG. 5 is a graph showing a relation between a scan pulse width (axis of abscissas) and maximum and minimum offset voltages (axis of coordinates).

Specifically, FIG. 5 illustrates a curve A showing a minimum offset voltage, and a curve B showing a maximum offset voltage.

Hereinbelow, a range of voltages sandwiched between the maximum and minimum offset voltages is referred to as an offset margin.

As illustrated in FIG. 5, the maximum offset voltage shown as the curve B becomes smaller as a scan pulse width becomes greater, and similarly, the minimum offset voltage shown as the curve A becomes smaller as a scan pulse width becomes greater.

The voltages indicated with the curves A and B in FIG. 5 are just examples, and are determined in accordance with characteristics of each of plasma display panels.

Since an offset voltage and a scan pulse width have a relation as shown in FIG. 5, the conventional method in which an offset voltage is kept constant cannot treat variance in an offset margin.

Accordingly, in the first embodiment, an offset voltage is varied in accordance with a scan pulse width along a curve E illustrated in FIG. 5 to thereby keep an offset voltage between a maximum offset voltage and a minimum offset voltage, that is, to keep an offset voltage within an offset margin.

For instance, as illustrated in FIG. 5, an offset voltage is varied in a step-shaped voltage such that an offset voltage becomes smaller as a scan pulse width becomes greater.

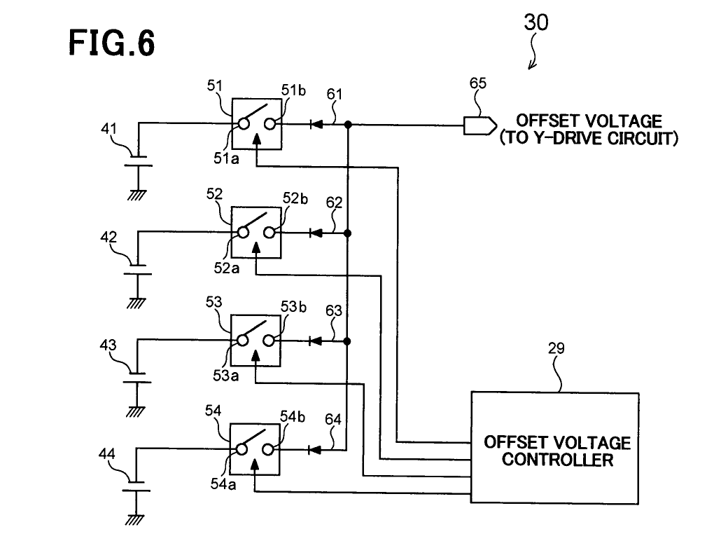

FIG. 6 is a circuit diagram of the offset voltage generator 30. The offset voltage generator 30 may be designed to have a structure illustrated in FIG. 6.

As illustrated in FIG. 6, the offset voltage generator 30 is comprised of a plurality of voltage sources 41, 42, 43 and 44 each associated with each of offset voltages, and a plurality of switches 51, 52, 53 and 54 each associated with each of the voltage sources 41, 42, 43 and 44.

The voltage source 41 supplies a first offset voltage E1 illustrated in FIG. 5, the voltage source 42 supplies a second offset voltage E2 illustrated in FIG. 5, the voltage source 43 supplies a third offset voltage E3 illustrated in FIG. 5, and the voltage source 44 supplies a fourth offset voltage E4 illustrated in FIG. 5.

The first offset voltage E1 is greater than the second offset voltage E2, the second offset voltage E2 is greater than the third offset voltage E3, and the third offset voltage E3 is greater than the fourth offset voltage E4. That is, a relation among the first to fourth offset voltages E1 to E4 is expressed as follows.

E1>E2>E3>E4

The switches 51, 52, 53 and 54 are electrically connected at first terminals 51a, 52a, 53a and 54a in series to the voltage sources 41, 42, 43 and 44, respectively.

Furthermore, the switches 51, 52, 53 and 54 are electrically connected at second terminals 51b, 52b, 53b and 54b in series to cathodes of diodes 61, 62, 63 and 64, respectively.

The diodes 61, 62, 63 and 64 have anodes electrically connected to an output terminal 65 through which an offset voltage is output from the voltage sources 41, 42, 43 and 44.

The diodes 61, 62, 63 and 64 prevent a current from running to the voltage sources 41, 42, 43 and 44 from other voltage sources.

The offset voltage controller 29 receives a signal indicative of an optimal offset voltage selected by the optimal offset voltage selector 27 in accordance with a scan pulse width selected by the scan-pulse width selector 23, and turns on one of the switches 51 to 54 which is associated with the offset voltage received from the optimal offset voltage selector 27.

For instance, if the switch 51 is turned on by the offset voltage controller 29, an offset voltage is output from the voltage source 41 electrically connected to the switch 51, to the Y-drive circuit 31 through the switch 51.

That is, the offset voltage controller 29 controls the switches 51 to 54 in accordance with the offset determined by the above-mentioned second device to select one of the switches 51 to 54 for allowing the associated offset voltage to output through the selected switch.

The sustaining-discharge number calculator 22, the scan-pulse width selector 23, the scan-pulse width controller 25, the optimal offset voltage selector 27, the offset voltage controller 29 and the Y-drive circuit 31 may be comprised of a microcomputer which operates in accordance with a program.

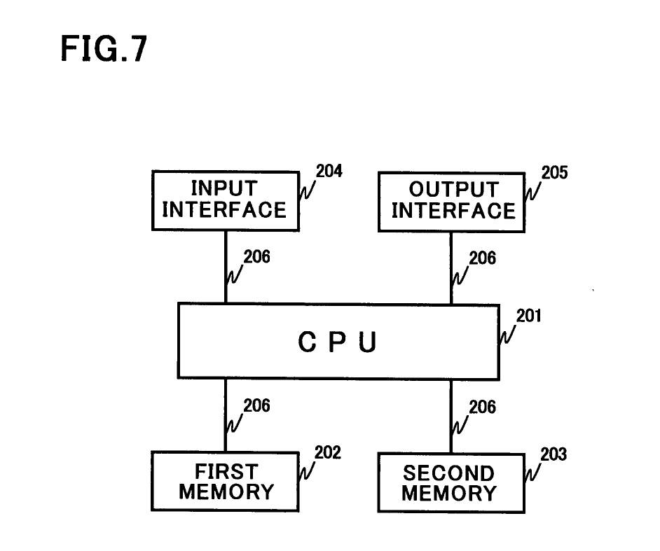

FIG. 7 is a block diagram of an example of such a microcomputer.

As illustrated in FIG. 7, the microcomputer is comprised of a central processing unit (CPU) 201, a first memory 202, a second memory 203, an input interface 204 through which a command and/or data is input into the central processing unit 201, an output interface 205 through which a result of steps having been executed by the central processing unit 201 is output, and a bus 206 through which the central processing unit 201 is electrically connected with the first memory 202, the second memory 203, the input interface 204, and the output interface 205.

Each of the first and second memories 202 and 203 is comprised of a semiconductor memory such as a read only memory (ROM), a random access memory (RAM) or an IC memory card, or a storage device such as a flexible disc, a hard disc or an optic magnetic disc.

In the first embodiment, the first memory 202 comprises a read only memory (ROM), and the second memory 203 comprises a random access memory (RAM).

The first memory 203 stores therein a program for causing the central processing unit 201 to carry out an operation of the above-mentioned sustaining-discharge number calculator 22, the scan-pulse width selector 23, the scan-pulse width controller 25, the optimal offset voltage selector 27, the offset voltage controller 29 and the Y-drive circuit 31.

The second memory 203 stores therein various data and parameters, and presents a working area to the central processing unit 201. The central processing unit 201 reads the program out of the first memory 202, and executes the program. Thus, the central processing unit 201 operates in accordance with the program stored in the first memory 202.

Specifically, the central processing unit 201, the first memory 202, and the second memory 203 functionally defines the above-mentioned sustaining-discharge number calculator 22, the scan-pulse width selector 23, the scan-pulse width controller 25, the optimal offset voltage selector 27, the offset voltage controller 29 and the Y-drive circuit 31.

FIG. 8 is an exploded perspective view of the plasma display panel 150.

As illustrated in FIG. 8, the plasma display panel 150 includes a front substrate 10 and a rear substrate 11 arranged in parallel relation with each other.

The front substrate 10 includes at a surface facing the rear substrate 11 at least one transparent scanning electrode 14 and at least one transparent sustaining electrode 15 both extending in a row direction (a left-right direction in FIG. 8) of the plasma display panel 150.

The front substrate 10 further includes a dielectric layer 19A formed on the front substrate 10 to cover the scanning electrode 14 and the sustaining electrode 15 therewith, and a protection layer 18 entirely covering the dielectric layer 19A therewith for protecting the dielectric layer 19A from discharges. The protection layer is composed of magnesium oxide, for instance.

The rear substrate 11 includes at a surface facing the front substrate 10 at least one data electrode (address electrode) 16 extending perpendicularly to the scanning electrode 14 and the sustaining electrode 15 when viewed perpendicularly to a plane defined by the plasma display panel 150.

The rear substrate 11 further includes a dielectric layer 19B formed on the rear substrate 11 to cover the data electrode 16 therewith, partition walls 12 standing on the dielectric layer 19B in the form of a wall and extending in a column direction, and dividing display cells in a row direction, and a phosphor layer 17 covering sidewalls of the partition walls 12 and an exposed surface of the dielectric layer 19B therewith.

The phosphor layer 17 converts ultraviolet rays generated due to discharges of discharge gas, into visible light.

There is formed a space between the front substrate 10 and the rear substrate 11. The space is divided by the partition walls 12 into a plurality of discharge spaces 13. Each of the discharge spaces 13 is filled with discharge gas.

The plasma display panel 150 includes a plurality of display cells arranged in a matrix such that each of the display cells is disposed on both a point closest to the scanning electrode 14 and the data electrode 16 and a point closest to the sustaining electrode 15 and the data electrode 16. Accordingly, the plasma display panel 150 includes n·m display cells.

### Second Embodiment

Hereinbelow is explained, as a second embodiment of the present invention, a plasma display apparatus including the plasma display panel 150 including the plasma display unit 100 in accordance with the above-mentioned first embodiment.

FIG. 9 is a block diagram of a plasma display apparatus 300 including the plasma display panel 150.

As illustrated in FIG. 9, the plasma display apparatus 300 has a modularized structure. Specifically, the plasma display apparatus 300 is comprised of an analog interface 120 and a plasma display panel module 130.

The plasma display panel module 130 includes the above-mentioned plasma display panel 150.

The analog interface 120 is comprised of a Y/C separating circuit 121 including a chroma-decoder, an analog-digital (A/D) converting circuit 122, a circuit 123 for controlling a synchronization signal, including a phase-lock loop (PLL) circuit, a circuit 124 for converting an image format, an reverse-gamma converting circuit 125, a system control circuit 126, and a PLE control circuit 127.

In brief, the analog interface 120 coverts a received analog image signal into a digital image signal, and then, outputs the digital image signal to the plasma display panel module 130.

For instance, an analog image signal transmitted from a television tuner (not illustrated) is separated into luminance signals for RGB (red, green and blue) colors in the Y/C separating circuit 121, and then, converted into an RGB digital signal in the A/D converting circuit 122.

Then, if a pixel configuration in the plasma display panel module 130 is different from a pixel configuration of the image signal, necessary conversion of image format is carried out in the image-format converting circuit 124.

A characteristic of a luminance to a signal input to a plasma display panel is linear. Image signals are usually compensated for, specifically, gamma-converted in advance in accordance with characteristics of a cathode ray tube (CRT). Hence, after the image signals are A/D-converted in the A/D converting circuit 122, reverse-gamma conversion is applied to the image signals are in the reverse-gamma converting circuit 125 for producing digital image signals having linear characteristics. The thus produced digital image signals are output to the plasma display panel module 130 as RGB image signals.

Since an analog image signal does not include a sampling clock signal and a data clock signal used for A/D conversion, the PLL circuit included in the control circuit 123 produces a sampling clock signal and a data clock signal, based on a horizontal synchronization signal provided together with the analog image signal, and outputs the clock signals to the plasma display panel module 130.

The PLE control circuit 127 carries out luminance (brightness) control. Specifically, if an average picture level is equal to or smaller than a threshold level, a luminance for displayed images is raised, and if an average picture level is greater than a threshold level, a luminance is reduced.

The system control circuit 126 outputs various control signals to the plasma display panel module 130.

The plasma display panel module 130 is comprised of a digital signal processing and controlling circuit 131, a panel section 132, and a power source circuit 133 including a DC/DC converter.

The digital signal processing and controlling circuit 131 is comprised of an input interface signal processing circuit 134, a frame memory 135, a memory control circuit 136, and a driver control circuit 137.

The plasma display unit 100 illustrated in FIG. 4 is equipped in the driver control circuit 337, for instance.

The interface signal processing circuit 134 receives various control signals transmitted from the system control circuit 126, an RGB image signal transmitted from the reverse-gamma converting circuit 125, a synchronization signal transmitted from the control circuit 123, and a data clock signal transmitted from the PLL circuit.

For instance, an average picture level (APL) of an image signal input into the interface signal processing circuit 134 is calculated in an APL calculating circuit (not illustrated) included in the input interface signal processing circuit 134, and output as 5-bit data, for instance. The PLE control circuit 127 arranges PLE control data in accordance with the calculated average picture level, and outputs the PLE control data to a picture level control circuit (not illustrated) included in the input interface signal processing circuit 134.

The digital signal processing and controlling circuit 131 processes those signals in the input interface signal processing circuit 134, and then, transmits a control signal to the panel section 132. The memory control circuit 336 transmits a memory control signal to the panel section 132, and the driver control circuit 337 transmits a driver control signal to the panel section 132.

The panel section 132 is comprised of a 50-size plasma display panel 150, a scanning driver 138 for driving a scanning electrode of the plasma display panel 150, data drivers 139 for driving data electrodes of the plasma display panel 150, pulse-generating circuits 140 for applying a pulse voltage to the plasma display panel 150 and the scanning driver 138, and a circuit 141 for collecting excess power supplied from the pulse-generating circuits 140.

The plasma display panel 150 is designed to have 1365×768 pixels, for instance. In the plasma display panel 150, the scanning driver 138 controls a scanning electrode, and the data drivers 139 control data electrodes (address electrodes), thereby a light is emitted from selected display cells for displaying images.

A first power source supplies power to the digital signal processing and controlling circuit 131 and the panel section 132. A power source circuit 133 receives DC power from a second power source, converts a DC voltage into a desired voltage, and supplies the desired voltage to the panel section 132.

Hereinbelow is explained a method of fabricating the plasma display apparatus 300.

First, the plasma display panel 150, the scanning driver 138, the data drivers 139, the pulse-generating circuits 140, and the power-collecting circuit 141 are arranged on a substrate to thereby fabricate the panel section 132.

Apart from the panel section 132, there is fabricated the digital signal processing and controlling circuit 131.

The panel section 132, the digital signal processing and controlling circuit 31 and the power source circuit 133 are assembled as a module. Thus, the plasma display panel module 130 is completed.

Apart from the plasma display panel module 130, there is fabricated the analog interface 120.

After the plasma display panel module 130 and the analog interface 120 have been fabricated separately from each other, they are electrically connected to each other. Thus, there is completed the plasma display apparatus 300 illustrated in FIG. 9.

By modularizing the plasma display apparatus 300, the plasma display panel 150 can be fabricated independently of other parts constituting the plasma display apparatus 300. For instance, if the plasma display panel 150 went wrong in the plasma display apparatus 300, the plasma display panel module 130 including the plasma display panel 150 having gone wrong can be exchanged into new one, ensuring simplification in repair and reduction in time for repair.

Furthermore, since the plasma display apparatus 300 includes the plasma display panel 150, the plasma display apparatus 300 provides high-quality images.

In the above-mentioned first embodiment, an offset voltage is varied in four voltages, as illustrated in FIG. 5. However, it should be noted that a number of stages in which an offset voltage is varied can be determined in dependence on characteristics of the plasma display panel 150.

For instance, if a rate in variance of the maximum and/or minimum offset voltages relative to a scan pulse width is high, a number of stages in which an offset voltage is varied can be increased, and, in contrast, if a rate in variance of the maximum and/or minimum offset voltages relative to a scan pulse width is small, a number of stages in which an offset voltage is varied can be decreased.

When an offset voltage is varied in steps as illustrated in FIG. 5, an offset voltage associated with each of steps may be determined independently of one another. As an alternative, a relation among offset voltages associated with the steps is kept constant (for instance, the curve E illustrated in FIG. 5 is kept as it is), only the offset voltages may be shifted upwardly or downwardly (for instance, the curve E illustrated in FIG. 5 is shifted upwardly or downwardly with the curve E being kept unchanged in shape).

How an offset voltage associated with each of steps is determined is dependent on panel characteristics, simplicity of circuits constituting a plasma display panel, fabrication costs, and so on.

In FIG. 5, the offset voltage is varied in a step-shaped voltage such that an offset voltage becomes smaller as a scan pulse width becomes greater. As an alternative, the offset voltage may be linearly varied or be varied in a curve such that an offset voltage becomes smaller as a scan pulse width becomes greater.

The plasma display unit 100 in accordance with the first embodiment may be driven in accordance with the selective erasion process or the selective writing process.

The above-mentioned first embodiment provides the plasma display unit 100 including the plasma display panel 150 having a plurality of display cells, wherein a display cell to be lit is selected among the display cells by applying a scan pulse thereto, and sustaining discharge is generated in the selected display cell for causing the selected display cell to light, the plasma display unit 100 including the first device (defined by the scan-pulse width selector 23 and the first table 24) for determining a width of a scan pulse in accordance with a delay time starting when a scan pulse is applied to a display cell and terminating when discharge is generated in the display cell, the second device (defined by the optimal offset voltage selector 27 and the second table 28) for determining an offset in a voltage of a scan pulse in accordance with a scan pulse width determined by the first device, the offset being defined as a voltage offset from a standard voltage, and the third device (defined by the Y-drive circuit 31) for outputting a scan pulse having the offset voltage defined as a sum of the standard voltage and the offset, to the plasma display panel.

The plasma display unit 100 makes it possible to set an offset voltage of a scan pulse within an offset margin, even if an offset margin is narrow. Accordingly, it is possible to broadly vary a range of a scan pulse width, even if an offset margin is narrow.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2006-091130 filed on Mar. 29, 2006 including specification, claims, drawings and summary is incorporated herein by reference in its entirety.

What is claimed is:

1. A plasma display unit including a plasma display panel having a plurality of display cells, wherein a display cell to be lit is selected among said display cells by applying a scan pulse thereto, and sustaining discharge is generated in the selected display cell for causing the selected display cell to light,
said plasma display unit comprising:
a first device for determining a width of a scan pulse in accordance with a delay time starting when a scan pulse is applied to a display cell and terminating when discharge is generated in said display cell;
a second device for determining an offset in a voltage of a scan pulse in accordance with a scan pulse width determined by said first device, said offset being defined as a voltage offset from a standard voltage; and
a third device for outputting a scan pulse having said offset voltage defined as a sum of said standard voltage and said offset, to said plasma display panel.

2. The plasma display unit as set forth in claim 1, wherein said second device includes:
a table storing therein both a plurality of scan pulse widths, and optimal offset voltages each associated with each of said scan pulse widths; and
a fourth device for retrieving said table to determine an optimal offset voltage associated with a scan pulse.

3. The plasma display unit as set forth in claim 1, further comprising:
a plurality of voltage sources each associated with each of a plurality of offset voltages;
a plurality of switches each associated with each of said voltage sources; and
a controller for controlling said switches in accordance with said offset determined by said second device to select one of said switches for allowing the associated offset voltage to output through the selected switch.

4. The plasma display unit as set forth in claim 1, wherein said second device varies said offset in a step-shaped voltage such that an offset voltage becomes smaller as a scan pulse width becomes greater.

5. The plasma display unit as set forth in claim 1, wherein said second device linearly varies said offset such that an offset voltage becomes smaller as a scan pulse width becomes greater.

6. The plasma display unit as set forth in claim 1, wherein said second device varies said offset in a curve such that an offset voltage becomes smaller as a scan pulse width becomes greater.

7. A method of driving a plasma display unit including a plasma display panel having a plurality of display cells, wherein a display cell to be lit is selected among said display cells by applying a scan pulse thereto, and sustaining discharge is generated in the selected display cell for causing the selected display cell to light,
said method comprising:
(a) determining a width of a scan pulse in accordance with a delay time starting when a scan pulse is applied to a display cell and terminating when discharge is generated in said display cell; and
(b) determining an offset in a voltage of a scan pulse in accordance with a scan pulse width determined by said, said offset being defined as a voltage offset from a standard voltage.

8. The method as set forth in claim 7, wherein said (b) includes retrieving a table to determine said offset, said table storing therein both a plurality of scan pulse widths, and optimal offsets each associated with each of said scan pulse widths.

9. A program for causing a computer to carry out a method of driving a plasma display unit including a plasma display panel having a plurality of display cells, wherein a display cell to be lit is selected among said display cells by applying a scan pulse thereto, and sustaining discharge is generated in the selected display cell for causing the selected display cell to light,
steps executed by said computer in accordance with said program, including:
(a) determining a width of a scan pulse in accordance with a delay time starting when a scan pulse is applied to a display cell and terminating when discharge is generated in said display cell; and
(b) determining an offset in a voltage of a scan pulse in accordance with a scan pulse width determined by said, said offset being defined as a voltage offset from a standard voltage.

10. The program as set forth in claim 9, wherein said (b) includes retrieving a table to determine said offset, said table storing therein both a plurality of scan pulse widths, and optimal offsets each associated with each of said scan pulse widths.
